(19) United States
(12) Patent Application Publication
(10) Pub. No.: US 2018/0113602 A1
(43) Pub. Date: Apr. 26, 2018

(54) MOBILE APPLICATION WITH VOICE AND GESTURE INTERFACE FOR FIELD INSTRUMENTS

(71) Applicant: Honeywell International Inc., Morris Plains, NJ (US)

(72) Inventors: Venkateswaran Chittoor Gopalakrishnan, Calicut (IN); Joseph Pane, North Wales, PA (US); Sharath Babu Malve, Rajendranagar Mandal (IN); Amol Gandhi, Bangalore (IN); Paul Dooner, Vancouver (CA)

(21) Appl. No.: 15/334,117

(22) Filed: Oct. 25, 2016

(51) Int. Cl. G06F 3/0484; H04W 4/00; H04L 29/08; G06F 3/16; G06F 3/01; G06F 3/0481; G05B 19/409

(52) U.S. Cl. CPC G06F 3/04847; H04W 4/008; H04L 67/12; G05B 2219/35444; G06F 3/017; G06F 3/0481; G05B 19/409; G06F 3/167

(57) ABSTRACT

A method includes communicating using a BLUETOOTH Low Energy (BLE) communication link with a plurality of field instruments in an industrial process and control system. The method also includes receiving operating parameters from each of the field instruments. The method further includes displaying an identifier of each field instrument and at least one operating parameter from each field instrument on a single screen or window of a wireless mobile device. The method also includes receiving a user input associated one or more operating parameters. In addition, the method includes transmitting data to or receiving information from a first field instrument based on the user input. In some embodiments, the method can also include receiving one or more voice or gesture commands related to operation of the field instruments, translating the voice or gesture commands to command data, and sending the command data to the field instruments.

### TECHNICAL FIELD

This disclosure relates generally to industrial control systems. More specifically, this disclosure relates to a mobile application with voice and gesture interface for field instruments in an industrial control system.

### BACKGROUND

Industrial process control and automation systems are often used to automate large and complex industrial processes, such as those in the chemical industry. These types of systems routinely include sensors, actuators, and controllers. The controllers typically receive measurements from the sensors and generate control signals for the actuators.

Such sensors and actuators comprise a group of devices commonly referred to field devices or field instruments. In production environments, field instruments often need to be accessed by a field technician to perform calibration, diagnostics, or other maintenance activities. In many cases, the field instruments are positioned in locations that are difficult or dangerous for a field technician to access.

### SUMMARY

This disclosure provides a mobile application with voice and gesture interface for field instruments and a method for use thereof.

In a first embodiment, a method includes communicating using a BLUETOOTH Low Energy (BLE) communication link with a plurality of field instruments in an industrial process and control system. The method also includes receiving operating parameters from each of the field instruments. The method further includes displaying an identifier of each field instrument and at least one of the operating parameters from each field instrument on a single screen or window of a wireless mobile device. The method also includes receiving a user input associated one or more of the operating parameters. In addition, the method includes transmitting data to or receiving information from a first one of the field instruments based on the received user input.

In a second embodiment, an apparatus includes at least one memory and at least one processor. The at least one memory is configured to store an application. The at least one processing device is configured when executing the application to communicate using a BLE communication link with a plurality of field instruments in an industrial process and control system. The at least one processing device is also configured to receive operating parameters from each of the field instruments. The at least one processing device is further configured to control display of an identifier of each field instrument and at least one of the operating parameters from each field instrument on a single screen or window of the apparatus. The at least one processor is also configured to receive a user input associated one or more of the operating parameters. In addition, the at least one processing device is configured to transmit data to or receive information from a first one of the field instruments based on the received user input.

In a third embodiment, a non-transitory computer readable medium contains instructions that, when executed by at least one processing device, cause the at least one processing device to communicate using a BLE communication link with a plurality of field instruments in an industrial process and control system. The medium also contains instructions that, when executed by the at least one processing device, cause the at least one processing device to receive operating parameters from each of the field instruments. The medium further contains instructions that, when executed by the at least one processing device, cause the at least one processing device to control display of an identifier of each field instrument and at least one of the operating parameters from each field instrument on a single screen or window of a wireless mobile device. The medium also contains instructions that, when executed by the at least one processing device, cause the at least one processing device to receive a user input associated one or more of the operating parameters. In addition, the medium contains instructions that, when executed by the at least one processing device, cause the at least one processing device to transmit data to or receive information from a first one of the field instruments based on the received user input.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates a field instrument interacting with a mobile device that is executing a mobile application in the system of FIG. 1 according to this disclosure;

FIG. 3 illustrates additional details of the mobile device and mobile application according to this disclosure;

FIG. 4 illustrates an example table for gesture and functionality mapping for use with the mobile application according to this disclosure;

FIG. 5 illustrates an example screen of the mobile application on a display of the mobile device according to this disclosure;

FIG. 6 illustrates an example method for using a mobile application to interact with a field instrument in a process control system according to this disclosure; and

FIG. 7 illustrates an example device for executing a mobile application to interact with a field instrument in a process control system according to this disclosure.

### DETAILED DESCRIPTION

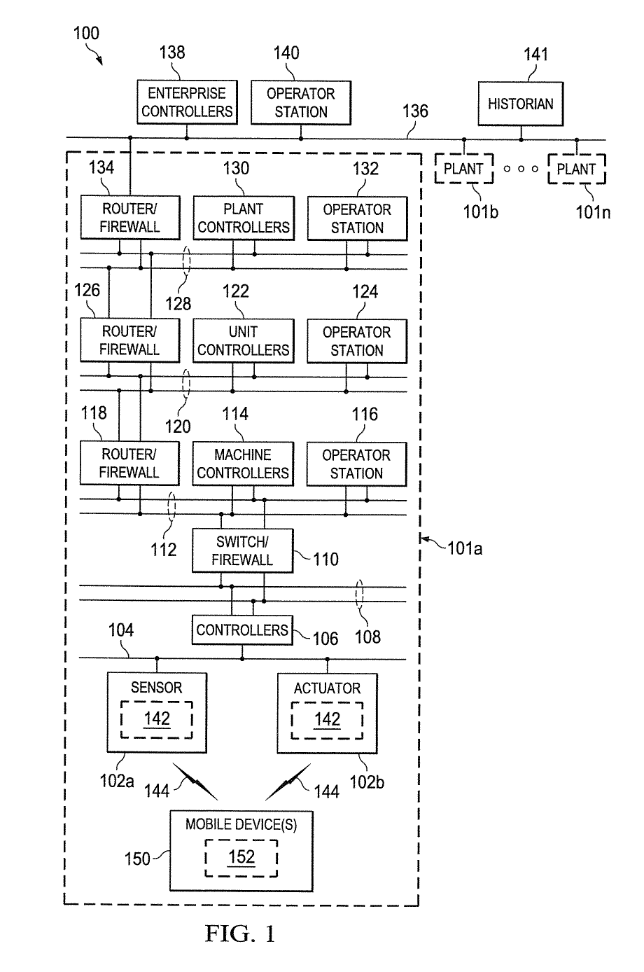

FIGS. 1 through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b (also collectively referred to as field instruments 102). The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 1026. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various supervisory functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Additionally or alternatively, each controller 114 could represent a multivariable controller embedded in a Distributed Control System (DCS), such as a RMPCT controller or other type of controller implementing MPC or other APC. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Additionally or alternatively, each controller 122 could represent a multivariable controller, such as a HONEYWELL C300 controller. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers and operator stations could include one or more processing devices and one or more memories for storing instructions and data used, generated, or collected by the processing device(s). Each of the controllers and operator stations could also include at least one network interface, such as one or more Ethernet interfaces or wireless transceivers.

In industrial process control and automation systems such as the system 100, technicians often use handheld communicators, such as a HONEYWELL field device configuration (FDC) or a similar communication device, to access field instruments for calibration, performing diagnostics, and the like. The field instruments include or are connected to field transmitters (also referred to as “smart transmitters”) that use industrial protocols (such as HART and FOUNDATION FIELDBUS protocols) in the field. Many manufacturing plants or other industrial facilities have remote areas, such as tank farms, water treatment facilities, well heads, remote platforms, and pipelines; and the field instruments within these industrial facilities are installed at difficult to access or hazardous locations. In order to use the handheld communicator, the technician needs to physically reach the field instrument at such locations, such as by climbing a ladder or crawling through a crawlspace. This can be inconvenient and potentially dangerous for the field technician.

In addition, using a conventional handheld device and applications, the field technician may be required to access field devices one at a time, and cannot get a consolidated status of multiple field devices effectively in one glimpse. Also, current handheld applications are often cumbersome to use. The technician may have to navigate into multiple menus to input commands to be sent to the device. Moreover, conventional handheld devices tend to be very application-focused, and do not have access to more general capabilities like Internet access, camera, voice interface, etc., that are present in devices like mobile phones. Therefore, the technician may have to carry multiple devices (such as a camera, walkie-talkie, etc.) in addition to the handheld communicator for various situations, such as when the technician needs to take a picture of a problem, or when the technician needs to communicate with people in the control room. This leads to a very poor user experience.

Furthermore, current handheld applications do not have menus that can be customized for different plant personnel. Typically, menus are unnecessarily static. In some plant environments, it is not necessary for all menu items to be displayed when different levels of plant personnel accesses the device. Currently, the user has to switch to multiple handhelds and multiple applications for communication with different device types. This is cumbersome when multiple field instruments which support different industrial protocols have to be accessed within a plant. Overall, these approaches for accessing field instruments lead to operational delays, higher costs, and have multiple potential failure modes.

To address these and other issues, one or more of the field instruments 102 (e.g., the sensors 102a, the actuators 1026, or any other suitable field instrument(s)) can include or be connected to a BLUETOOTH Low Energy (BLE) transceiver 142 configured for BLE communication with a mobile device 150 over a BLE communication link 144. The mobile device 150 represents a wireless communication device such as a smart phone, tablet, laptop, and the like. The mobile device 150 is configured to access field instrument parameters over the BLE communication link 144. The wireless BLE access solves the problem of inaccessible locations by enabling wireless access (by the mobile device 150) to field instrument parameters from a convenient location. Further details regarding the BLE transceiver 142 and the BLE communication link 144 can be found in the Applicant's co-pending application U.S. patent application Ser. No. 15/177,217, filed Jun. 8, 2016, the contents of which are incorporated by reference herein.

In accordance with this disclosure, the mobile device 150 may store and execute a flexible and robust mobile application 152 with voice and gesture interface. The mobile application 152 is a field protocol-agnostic application that is compatible with HART, FOUNDATION FIELDBUS, and any other suitable communication protocols. The mobile application 152 can provide status for multiple field instruments 102 in one screen. Thus, a technician can easily access multiple devices in a short time. In addition, the mobile application 152 responds to voice and gesture inputs from the technician. Additional details regarding the mobile application 152 are provided below.

Although FIG. 1 illustrates one example of an industrial process control and automation system 100, various changes may be made to FIG. 1. For example, a control system could include any number of sensors, actuators, controllers, servers, operator stations, networks, and safety managers. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs. In addition, while FIG. 1 illustrates one example environment in which a flexible and robust mobile application can be used, such a mobile application can be used in any other suitable device or system.

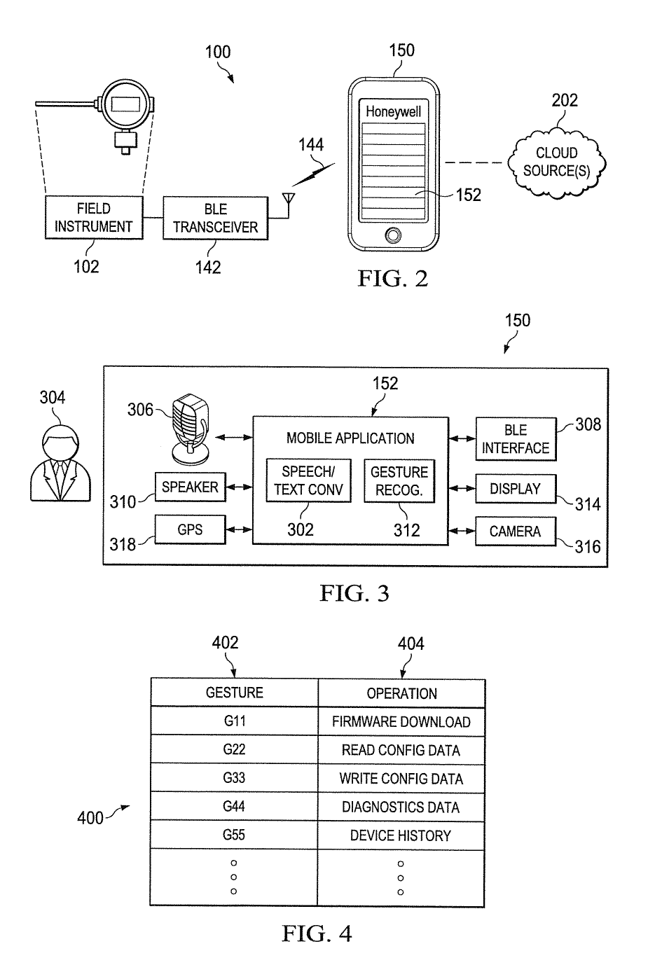

FIG. 2 illustrates additional details of a field instrument 102 interacting with a mobile device 150 that is executing the mobile application 152 in the system 100 according to this disclosure.

As shown in FIG. 2, the mobile device 150 is executing the mobile application 152, and a screen of the mobile application 152 is shown on a display of the mobile device 150. As discussed above, the mobile application 152 is a field protocol-agnostic, BLE-ready application that allows plant personnel to access multiple field instruments or other industrial devices at a single time, thereby shortening maintenance times. The mobile application 152 can provide status of multiple field instruments in one screen or window.

The mobile application 152 is configured to access field instrument parameters from the BLE-enabled field instrument 102 over the BLE communication link 144. A user technician can execute the mobile application 152 on the mobile device 150, which can be either a standard mobile phone or a specialized, explosion-proof mobile phone.

Because the mobile device 150 is configured for wireless communication, the mobile device 150 can also establish a wireless (e.g., Wi-Fi, cellular, etc.) communication link with one or more cloud-based services or information sources 202. In some embodiments, the mobile application 152 can receive firmware for the field instrument 102 from the cloud source 202, and then load the firmware to the field instrument 102 over the BLE communication link 144. In some embodiments, the firmware can additionally or alternatively be fetched from a local memory of the mobile device 150. In addition, the mobile application 152 can save configuration information of a field instrument 102 to a file stored offline (such as in the cloud-based information source(s) 202, and transmit the configuration file back to the field instrument 102 or a different field instrument 102 in accordance with a user request.

Using the wireless communication capabilities of the mobile device 150, the mobile application 152 can communicate with the other components of the system 100 (such as one or more of the operator stations 116, 124, 132, 140) over a wireless connection or over the Internet to send and receive information. With this connectivity, the mobile application 152 enables the user to remotely view information like alarms, a list of devices scheduled for maintenance, operator notes, etc., for the devices in the area where the user is currently located, and a list of devices that the user is scheduled to go to next. In particular, the mobile application 152 can leverage device and product line specific analytics available within or outside the system 100 (e.g., over the Internet) to provide the user with helpful information for enhanced understanding of field instruments and related processes as well as aid in troubleshooting.

FIG. 3 illustrates additional details of the mobile device 150 and mobile application 152 according to this disclosure. The mobile application 152 includes a speech-text conversion module 302 that can process voice commands using a defined structured language from a user 304. For example, the user 304 can speak voice commands into a microphone 306 disposed in the mobile device 150. As a particular example, the user 304 may speak a status request such as “What is the pressure reading of instrument 5?” into the microphone 306. The speech-text conversion module 302 of the mobile application 152 interprets the voice commands and translates them to command data, instruction data, or request data to be sent over a BLE interface 308 to a nearby field instrument 102. In addition, the speech-text conversion module 302 can receive text data, such as status data, from a field instrument 102, and translate the text data to voice data, which can be output by a speaker 310 disposed in the mobile device 150 and heard by the user 304. Speech-to-text and text-to-speech conversion is integrated in the speech-text conversion module 302 to enhance user experience. In some embodiments, the speech-text conversion module 302 recognizes and supports multiple spoken languages.

The mobile application 152 also includes a gesture recognition module 312 that can process gestures received from the user. The gesture recognition module 312 receives inputs to a touch-screen display 314 of the mobile device 150, such as touch, hover, multi touch, and force touch, and interprets the inputs as various touch based gestures. The gesture recognition module 312 also recognizes touchless gestures captured by a camera 316 of the mobile device 150 based on image recognition techniques. The gesture recognition module 312 of the mobile application 152 interprets the gestures and translates them to command data, instruction data, or request data to be sent over the BLE interface 308 to a nearby field instrument 102. Gesture-to-command conversion is integrated in the gesture recognition module 312 to enhance user experience. The camera 316 can also be used to capture pictures of field instruments 102. The pictures can be used with the voice commands or gesture commands to further enhance the user experience.

The mobile application 152 is also configured to access GPS information from a GPS module 318 of the mobile device 150. Using the GPS information, the mobile application 152 can navigate the user 304 to a field instrument 102 using a combination of outdoor and indoor maps, current GPS coordinates of the mobile device 150, and any GPS coordinates already available on the field instrument 102. The mobile application can also use the GPS information to program GPS-related values to field instrument parameters. For example, the mobile application 152 could establish the GPS location of a field instrument 102 and associate that location with the field instrument 102.

Using the components described in FIGS. 2 and 3, the mobile application 152 can share information with support teams with minimum turnaround time and with robust details, including parameter values, screen captures, and any text, audio, video, or images added by the user.

Although FIGS. 2 and 3 illustrate examples of a field instrument 102, a mobile device 150, and a mobile application 152, various changes may be made to FIGS. 2 and 3. For example, field instruments and mobile devices come in a wide variety of configurations, and applications can include a variety of functions and modules. The components shown in FIGS. 2 and 3 are meant to illustrate one example type of these components and does not limit this disclosure to a particular type of field instrument, mobile device, or mobile application.

FIG. 4 illustrates an example table 400 for gesture and functionality mapping for use with the mobile application 152 according to this disclosure. As shown in FIG. 4, the table 400 includes a list of gesture identifiers 402 and a corresponding list of operations 404. Each gesture identifier 402 identifies a particular gesture that is recognized by the mobile application 152. For example, ‘G11’ may refer to an open-hand wave, while ‘G22’ may refer to a one-finger swipe right. Once a gesture is detected, the mobile application 152 can determine the gesture identifier 402, select the operation 404 that corresponds to the gesture identifier 402, and transmit the operation 404 as command data to one or more field instruments 102.

Although FIG. 4 illustrates one example of a table 400 for gesture and functionality mapping, various changes may be made to FIG. 4. For example, data tables and data structures come in a wide variety of configurations and formats. The table 400 shown in FIG. 4 is meant to illustrate one example type of data table and does not limit this disclosure to a particular type of data structure.

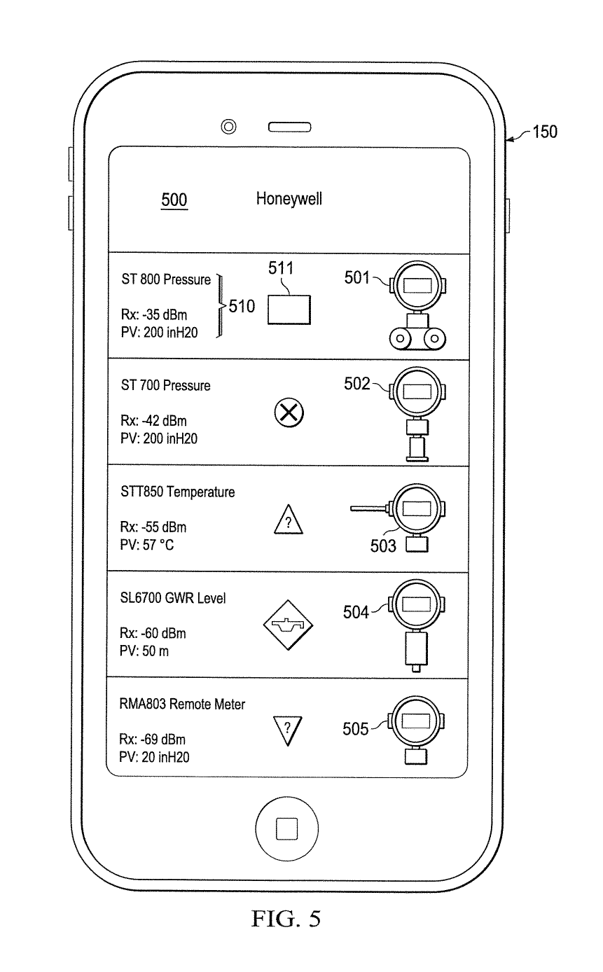

FIG. 5 illustrates an example screen 500 of the mobile application 152 on a display of the mobile device 150 according to this disclosure.

As shown in FIG. 5, the screen 500 is a summary screen that shows high-level details related to multiple field instruments 501-505. Each displayed field instrument 501-505 represents an actual field instrument 102 that has been discovered by the mobile device 150 using BLE communication. In some embodiments, the image of each field instrument 501-505 resembles the form factor of the represented field instrument 102. In some embodiments, the mobile application 152 can control the mobile device 150 to scan and identify all BLE-enabled field instruments 102 that are within BLE communication range. The field instruments 501-505 are then arranged on the screen 500 in order of proximity of the respective field instruments 102 to the mobile device 150. For example, field instruments 102 that are further from the mobile device 150 can be displayed further down the screen 500. In some embodiments, the mobile application 152 can display a calculated distance to each field instrument 102.

Next to each field instrument 501-505, one or more operating parameters 510 associated with the field instrument are displayed. Example operating parameters 510 can include pressure, temperature, fluid level, meter reading, position, speed, velocity, elapsed time, and the like. The screen 500 also can display a health indicator symbol 511 for each field instrument 501-505. The health indicator symbol 511 provides a quick at-a-glance indication of the overall health or status of the corresponding field instrument 102. In some embodiments, the mobile application 152 can show a high-level condensed health indication using the NAMUR NE 107 specification in accordance with NAMUR, the international user association for automation technology in the process industries. The mobile application 152 also includes additional detailed health and status information in one or more detail screens or windows that can be accessed when a user selects a menu option or actuates a control on the screen 500.

In one or more embodiments, the mobile application 152 can include one, some, or all of the following features. The mobile application 152 can include user interface menu options on the screen 500 or other screens. The user interface menu options can be customized by plant personnel, such as device users or system managers. The mobile application 152 can include one or more screens that allow configurable read and write field instrument parameters. The mobile application 152 can include one or more wizards that guide the user through common operations like field instrument calibration and trouble shooting.

Although FIG. 5 illustrates one example of a screen 500 of a mobile application 152, various changes may be made to FIG. 5. For example, user interfaces come in a wide variety of configurations and can include a wide variety of information and controls. The screen 500 shown in FIG. 5 is meant to illustrate one example type of user interface and does not limit this disclosure to a particular type of user interface.

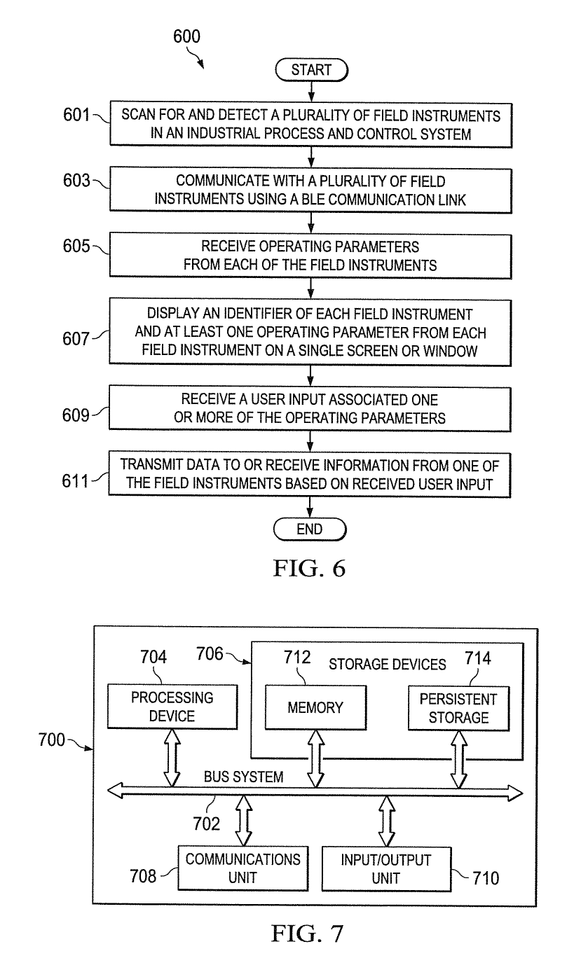

FIG. 6 illustrates an example method 600 for using a mobile application to interact with a field instrument in a process control system according to this disclosure. For ease of explanation, the method 600 is described as being performed using the mobile device 150 and the mobile application 152. However, the method 600 could be used with any suitable device, system, or application.

At step 601, a wireless mobile device, executing a mobile application, scans for and detects a plurality of field instruments in an industrial process and control system. This may include, for example, the mobile device 150 executing the mobile application 152 and detecting a plurality of field instruments 102 in the system 100 using BLE.

At step 603, the mobile device, executing the mobile application, communicates with a plurality of field instruments using a BLE communication link. This may include, for example, the mobile device 150 executing the mobile application 152 and communicating with the plurality of detected field instruments 102 in the system 100.

At step 605, the mobile device receives operating parameters from each of the field instruments. This may include, for example, the mobile device 150 receiving pressure, temperature, fluid level, meter reading, position, speed, velocity, elapsed time, or the like from each of the detected field instruments 102 in the system 100.

At step 607, the mobile application displays an identifier of each field instrument and at least one of the operating parameters from each field instrument on a single screen or window of the mobile device. This may include, for example, the mobile application 152 displaying the field instruments 501-505, the operating parameters 510, and the health indicator symbols 511 on the screen 500. In some embodiments, the identifiers and operating parameters are arranged on the screen or window in order of proximity of the field instruments to the mobile device 150.

At step 609, the mobile application receives a user input associated one or more of the operating parameters. This may include, for example, the mobile application 152 receiving a status request or an operating parameter update for one of the detected field instruments 102 from a user. In some embodiments, the user input may include one or more voice commands or one or more gesture commands from the user.

At step 611, the mobile application transmits data to or receives information from one of the field instruments based on the received user input. This may include, for example, the mobile application 152 receiving a status of one of the field instruments 102. This may also include the mobile application 152 transmitting an operating parameter update command to the field instrument 102.

Although FIG. 6 illustrates one example of a method 600 for a mobile application to interact with a field instrument in a process control system, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs. In addition, while the method 600 is described with respect to the mobile device 150 and the mobile application 152, which was described with respect to an industrial process control and automation system, the method 600 may be used in conjunction with other types of devices, systems, and applications.

FIG. 7 illustrates an example device 700 for executing a mobile application to interact with a field instrument in a process control system according to this disclosure. The device 700 could, for example, represent the mobile device 150. The device 700 could represent any other suitable device for executing a mobile application to interact with a field instrument in a process control system.

As shown in FIG. 7, the device 700 can include a bus system 702, which supports communication between at least one processing device 704, at least one storage device 706, at least one communications unit 708, and at least one input/output (I/O) unit 710. The processing device 704 executes instructions that may be loaded into a memory 712. The processing device 704 may include any suitable number(s) and type(s) of processors or other devices in any suitable arrangement. Example types of processing devices 704 include microprocessors, microcontrollers, digital signal processors, field programmable gate arrays, application specific integrated circuits, and discrete circuitry.

The memory 712 and a persistent storage 714 are examples of storage devices 706, which represent any structure(s) capable of storing and facilitating retrieval of information (such as data, program code, and/or other suitable information on a temporary or permanent basis). The memory 712 may represent a random access memory or any other suitable volatile or non-volatile storage device(s). The persistent storage 714 may contain one or more components or devices supporting longer-term storage of data, such as a ready only memory, hard drive, Flash memory, or optical disc. In accordance with this disclosure, the memory 712 and the persistent storage 714 may be configured to store instructions associated with a mobile application for interacting with a field instrument in a process control system.

The communications unit 708 supports communications with other systems, devices, or networks, such as the networks 110-120. For example, the communications unit 708 could include a network interface that facilitates communications over at least one Ethernet network. The communications unit 708 could also include a wireless transceiver facilitating communications over at least one wireless network. The communications unit 708 may support communications through any suitable physical or wireless communication link(s) (e.g., the BLE interface 308, the GPS module 318, etc.).

The I/O unit 710 allows for input and output of data. For example, the I/O unit 710 may provide a connection for user input through a keyboard, mouse, keypad, touchscreen, or other suitable input device (e.g., the microphone 306, the display 314, etc.). The I/O unit 710 may also send output to a display, printer, or other suitable output device (e.g., the speaker 310, the display 314, etc.).

Although FIG. 7 illustrates one example of a device 700 for executing a mobile application to interact with a field instrument in a process control system, various changes may be made to FIG. 7. For example, various components in FIG. 7 could be combined, further subdivided, or omitted and additional components could be added according to particular needs. Also, computing devices can come in a wide variety of configurations, and FIG. 7 does not limit this disclosure to any particular configuration of device.

As described above, embodiments of the mobile application can enhance operator effectiveness and productivity. Because the mobile application can be executed on a standard wireless communication device, there can be significant savings in capital costs since fewer specialized handhelds need to be procured. Similarly, use of a standard wireless communication device reduces the number of specialized tools that must be carried, thus enhancing overall user experience, and lowers the technology bar in geographical areas having reduced information services support. The improved error and data collection techniques supported by the mobile application is helpful for remote support, while the support for multitasking provides a better user experience.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware or a combination of hardware and software/firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
communicating using a BLUETOOTH Low Energy (BLE) communication link with a plurality of field instruments in an industrial process and control system;
receiving operating parameters from each of the field instruments;
displaying an identifier of each field instrument and at least one of the operating parameters from each field instrument on a single screen or window of a wireless mobile device;
receiving a user input associated one or more of the operating parameters; and
transmitting data to or receiving information from a first one of the field instruments based on the received user input.

2. The method of claim 1, wherein:
the user input comprises a status request; and
transmitting data to or receiving information from the first field instrument comprises receiving a status of the first field instrument from the first field instrument.

3. The method of claim 1, wherein:
wherein the user input comprises an operating parameter update; and
transmitting data to or receiving information from the first field instrument comprises transmitting an operating parameter update command to the first field instrument.

4. The method of claim 1, wherein the identifiers and operating parameters are arranged on the screen or window in order of proximity of the field instruments to the mobile device.

5. The method of claim 1, further comprising:
receiving one or more voice commands related to operation of one or more of the field instruments;
translating the one or more voice commands to command data; and
sending the command data to the one or more of the field instruments.

6. The method of claim 1, further comprising:
receiving one or more gesture commands related to operation of one or more of the field instruments;
translating the one or more gesture commands to command data; and
sending the command data to the one or more of the field instruments.

7. The method of claim 6, wherein at least one of the one or more gesture commands is received as a video image from a camera of the mobile device.

8. The method of claim 1, further comprising:
receiving firmware for the first field instrument from an Internet-based source over a Wi-Fi or cellular network; and
transmitting the firmware to the first field instrument over the BLE communication link.

9. The method of claim 1, further comprising:
scanning for and detecting the plurality of field instruments using BLE.

10. An apparatus comprising:
at least one memory configured to store an application; and
at least one processing device configured when executing the application to:
communicate using a BLUETOOTH Low Energy (BLE) communication link with a plurality of field instruments in an industrial process and control system;
receive operating parameters from each of the field instruments;
control display of an identifier of each field instrument and at least one of the operating parameters from each field instrument on a single screen or window of the apparatus;
receive a user input associated one or more of the operating parameters; and
transmit data to or receive information from a first one of the field instruments based on the received user input.

11. The apparatus of claim 10, wherein:
the user input comprises a status request; and
the at least one processing device is configured to transmit data to or receive information from the first field instrument by receiving a status of the first field instrument from the first field instrument.

12. The apparatus of claim 10, wherein:
wherein the user input comprises an operating parameter update; and
the at least one processing device is configured to transmit data to or receive information from the first field instrument by transmitting an operating parameter update command to the first field instrument.

13. The apparatus of claim 10, wherein the identifiers and operating parameters are arranged on the screen or window in order of proximity of the field instruments to the apparatus.

14. The apparatus of claim 10, wherein the at least one processing device is further configured to:
receive one or more voice commands related to operation of one or more of the field instruments;
translate the one or more voice commands to command data; and
send the command data to the one or more of the field instruments.

15. The apparatus of claim 10, wherein the at least one processing device is further configured to:
receive one or more gesture commands related to operation of one or more of the field instruments;
translate the one or more gesture commands to command data; and
send the command data to the one or more of the field instruments.

16. The apparatus of claim 15, wherein at least one of the one or more gesture commands is received as a video image from a camera of the mobile device.

17. The apparatus of claim 10, wherein the at least one processing device is further configured to:
receive firmware for the first field instrument from an Internet-based source over a Wi-Fi or cellular network; and
transmit the firmware to the first field instrument over the BLE communication link.

18. The apparatus of claim 10, wherein the at least one processing device is further configured to:
scan for and detect the plurality of field instruments using BLE.

19. A non-transitory computer readable medium containing instructions that, when executed by at least one processing device, cause the at least one processing device to:
communicate using a BLUETOOTH Low Energy (BLE) communication link with a plurality of field instruments in an industrial process and control system;
receive operating parameters from each of the field instruments;
control display of an identifier of each field instrument and at least one of the operating parameters from each field instrument on a single screen or window of a wireless mobile device;
receive a user input associated one or more of the operating parameters; and
transmit data to or receive information from a first one of the field instruments based on the received user input.

20. The non-transitory computer readable medium of claim 15, wherein:
the user input comprises a status request; and
the instructions that cause the at least one processing device to transmit data to or receive information from the first field instrument comprise instructions that cause the at least one processing device to receive a status of the first field instrument from the first field instrument.
